(19) United States
(12) Patent Application Publication
(10) Pub. No.: US 2010/0161769 A1
(43) Pub. Date: Jun. 24, 2010

(54) Method and System for Virtual LAN Media Access Control Trouble Diagnostics

(76) Inventors: Zhiqiang QIAN, Holmdel, NJ (US); Paritosh Bajpay, Edison, NJ (US); Shailendra Borale, Tinton Falls, NJ (US); Jackson Liu, Middletown, NJ (US); Michael Zinnikas, North Brunswick, NJ (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/338,267

(22) Filed: Dec. 18, 2008

(51) Int. Cl. G06F 15/16; G06F 15/177; G06N 5/02

(52) U.S. Cl. 709/221; 709/224; 709/223; 706/47

(57) ABSTRACT

Described herein are systems and methods for automatically troubleshooting problems related to Media Access Control (“MAC”) address limit problems within a virtual local area network (“VLAN”). An exemplary method includes identifying a media access control (“MAC”) address alert within a network, referencing a translation table of a plurality of MAC addresses to detect a whether a number of MAC addresses in the network exceeds a threshold number, and providing a solution for the MAC address alert. An exemplary system includes a rules building engine for identifying a media access control (“MAC”) address alert within a network, referencing a translation table of a plurality of MAC addresses to detect a whether a number of MAC addresses in the network exceeds a threshold number, and providing a solution for the MAC address alert. A further exemplary embodiment is related to a computer readable storage medium storing a set of instructions executable by a processor, the set of instructions being operable to identify a media access control (“MAC”) address alert within a network, reference a translation table of a plurality of MAC addresses to detect a whether a number of MAC addresses in the network exceeds a threshold number, and provide a solution for the MAC address alert.

### BACKGROUND

The Media Access Control (“MAC”) data communication protocol sub-layer may be defined as a sub-layer of the Data Link Layer specified in the seven-layer Open Systems Interconnection (“OSI”) model (i.e., layer 2 of the OSI model). The MAC sub-layer provides addressing and channel access control mechanisms that make it possible for several terminals or network nodes to communicate within a multipoint network, such as, for example, within a local area network (“LAN”). Accordingly, the MAC sub-layer acts as an interface between the Logical Link Control (“LLC”) sub-layer of the Data Link Layer and the network's physical layer (i.e., layer 1 of the OSI model). In addition, the MAC layer may emulate a full-duplex logical communication channel in a multipoint network, wherein this channel may provide any one of unicast, multicast, and broadcast communication service. Furthermore, a MAC address may be used to uniquely identify any network devices within the LAN.

A virtual local area network (“VLAN”) may be defined as a group of hosts with a common set of requirements that communicate as if they were attached to the Broadcast domain, regardless of their physical location. A VLAN has the same attributes as a physical LAN, but it allows for end stations to be grouped together even if they are not located on the same network switch. Network reconfiguration can be done through software instead of physically relocating devices.

In order to ensure the quality of service within a VLAN configuration, each VLAN may be limited to support a specific amount of network connections as defined by a translation table. Specifically, the translation table may map the MAC addresses of each network connection to a physical port. In the case that the number of MAC addresses had exceeded a limit for a VLAN, any overflow information (e.g., data packets) with MAC address will be dropped, thereby disrupting the quality of service. However, during the disruption in service, the network equipment and facility may appear to be in working order. Therefore, a technician may not be able to locate the cause of this disruption in a timely manner.

### SUMMARY OF THE INVENTION

The present invention is generally related to systems and methods for automatically troubleshooting problems related to Media Access Control (“MAC”) address limit problems within a virtual local area network (“VLAN”). One exemplary embodiment is related to a method including identifying a media access control (“MAC”) address alert within a network, referencing a translation table of a plurality of MAC addresses to detect a whether a number of MAC addresses in the network exceeds a threshold number, and providing a solution for the MAC address alert.

A further exemplary embodiment is related to a system including a rules building engine for identifying a MAC address alert within a network, referencing a translation table of a plurality of MAC addresses to detect a whether a number of MAC addresses in the network exceeds a threshold number, and providing a solution for the MAC address alert.

A further exemplary embodiment is related to a computer readable storage medium storing a set of instructions executable by a processor, the set of instructions being operable to identify a MAC address alert within a network, reference a translation table of a plurality of MAC addresses to detect a whether a number of MAC addresses in the network exceeds a threshold number, and provide a solution for the MAC address alert.

### BRIEF DESCRIPTION OF THE DRAWINGS

FIG. 1 shows an exemplary communication system for automatically troubleshooting problems related to MAC address limit problems within a VLAN according to an exemplary embodiment of the present invention.

FIG. 2 shows an exemplary rules engine within a communication system for automatic trouble diagnostics for MAC address limit problems within a VLAN according to an exemplary embodiment of the present invention.

FIG. 3 shows an exemplary method for automatically performing trouble diagnostics on MAC address limit problems within a VLAN according to an exemplary embodiment of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for automatically troubleshooting problems related to Media Access Control (“MAC”) address limit problems within a virtual local area network (“VLAN”). In addition, the exemplary embodiments may serve as a tool for preventing and/or minimizing any downtime resulting from an exceeded limit. Accordingly, the exemplary embodiments may allow for telecommunication service carriers to avoid relying on labor-intensive and time-consuming manual work in order to troubleshoot MAC address problems.

One skilled in the art of information technology would understand that data transmitted throughout a network, such as a VLAN, may be in the form of “packets”. Accordingly, a packet may be defined as a formatted unit of data routed between an origin and a destination on a network (e.g., the Internet or any other packet-switched network). A packet may consist of two kinds of data, namely, control data and user data. The control information may provide information about the network in order to deliver the user data, such as, for example, origin and destination addresses (e.g., MAC addresses), error detection codes, sequencing information, etc. While the user data may contain the “payload” or the body of the packet (e.g., the actual data to be delivered).

An exemplary manner in which these data packets may be communicated would be an Ethernet-based network. Ethernet may be described as a grouping of frame-based computer networking technologies for a network, such as a LAN or a VLAN. In addition, an Ethernet port may be described as a socket on a computer or network device for plugging in an Ethernet cable in order to allow for Ethernet-based communication between computers and network devices. Ethernet ports may provide both hard-wired and wireless communications throughout Ethernet networks.

Accordingly, Ethernet may classify a number of wiring and signaling standards for the Physical Layer of the OSI networking model, through means of network access at the MAC/Data Link Layer and an addressing format. Specifically, each Ethernet station may be given a single MAC address that may be used to specify both the destination and the source of each data packet. Furthermore, as Ethernet services and technology evolve, the rate of data transmission continues to experience dramatic improvements. These rates can vary from Gigabit Ethernet (“1 GigE”) for transmitting Ethernet frames at a rate of a Gbit/s, to 10 Gigabit Ethernet (“10 GigE”) having a nominal data rate of 10 Gbit/s, to even 40 Gigabit Ethernet (“40 GigE”) and 100 Gigabit Ethernet (“100 GigE”). It should be noted that while the exemplary embodiments of the present invention may be in reference to 10 GigE, the scope of the present invention may be applied to any type of address-based network communication using any rate of data transmission. Furthermore, it should be noted that standard 10 GigE access may also be offered over a synchronous optical networking (“SONET”) protocol.

In order to fully utilize a 10 Gigabyte Ethernet (“GigE”) port, a VLAN protocol of various speeds may be employed. As will be described in detail below, a service provider may provide a number of customers virtual private network (“VPN”) services on several VLANs using a GigE card. However, to ensure the quality of the respective VLANs, each of the VLANs may be limited to support a certain amount of network connections, as defined by a translation table. As described above, the translation table may map the MAC addresses of each network connection to a physical port. If the number of MAC addresses exceeds the limits for a VLAN, any exceeded packets with MAC addresses will be dropped. Therefore, the quality of service provided to the customer may be adversely impacted.

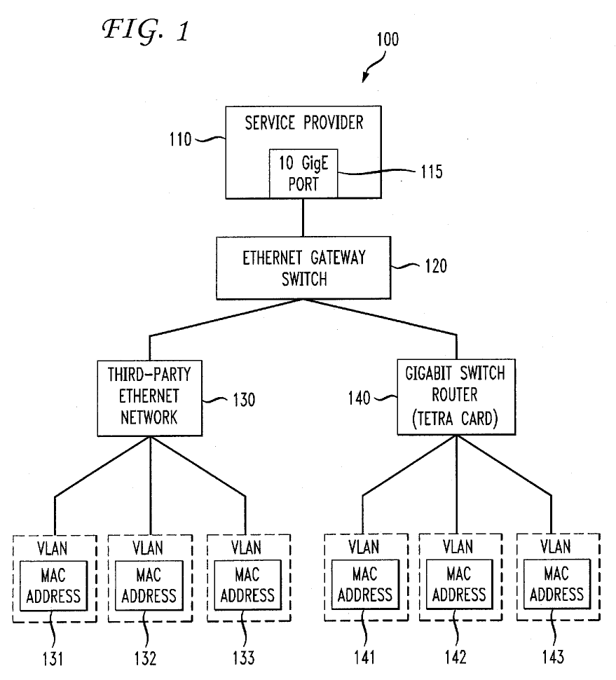

FIG. 1 shows an exemplary communication system 100 automatically troubleshooting problems related to MAC address limit problems within a VLAN according to an exemplary embodiment of the present invention. The communication system 100 may include a service provider 110 (e.g., a telecommunication carrier), and at least one network switching device. For example, the service provider 110 may provide customers the capacity to support high-bandwidth local access as well as high-bandwidth Internet access. The switching device may be, for example, an Ethernet gateway switch 120. The Ethernet gateway switch 120 may be connected to networks and communication interfaces external to the service provider 110, such as, for example, a third-party Ethernet network 130 and gigabit switch router (“GSR”) tetra card 140 (e.g., provider equipment (“PE”) router).

Each of these external networks and/or interfaces may be in communication with a plurality of VLANs having any number of network devices. For example, the VLANs connected to the third-party Ethernet network 130 may include devices 131-133, wherein each device includes a unique MAC address. The VLANs connected to the GSR tetra card 140 may include further devices 141-143, wherein each device includes a unique MAC address. Each of theses external networks and/or interfaces may be connected to the service provider 110 via a 10 GigE port 115. Accordingly, the service provider 110 may provision a single customer on multiple VLANs or multiple customers on multiple VLANs on the single 10 GigE port 115. It should be noted that while the system 100 illustrated in FIG. 1 includes one Ethernet network 130 and one Tetra Card 140, any number of external networks and communication interfaces may be connect to the switch 120 and subsequently analyzed by the service provider 110. Furthermore, it should be noted that the service provider 110 may include an number of 10 GigE ports and/or further ports of varying rates of transmission.

As described above, the number of MAC addresses on a customer's VLAN may exceed the limited number of network connections available to that VLAN. In other words, each of the VLANs may have a threshold for the number of MAC addresses it may support (e.g., 100 unique MAC addresses). When this threshold is exceeded, any packets from additional MAC addresses may be dropped or otherwise not received by the customer. Accordingly, these lost packets may diminish the quality of service offered by the service provider 110. Furthermore, timely identification of the transmission problem may be difficult since the Ethernet equipment may prove to be in full working order while the service to the customer is out or interrupted. Thus, the service provider 110 may not be aware of the packet loss until the customer contacts the service provider 110.

According to the exemplary embodiments of the present invention, the service provider 110 may be able to automatically troubleshoot any problems related to the MAC address limits of the VLANS. As will be described in greater detail below, this automatic troubleshooting may minimize and/or prevent any service disruptions (e.g., downtown) in the case wherein the MAC address limit had been exceeded. Specifically, the exemplary embodiments may promote “zero touch” service-assurance automation (e.g., requiring a minimal amount of manual, hands-on effort from the service provider 110). This will lead to improvements in operations efficiency, thereby elevating customer satisfaction through the provision of value-added services. Thus, the service provider 110 may be capable of maintaining its current clientele base while expanding services to new customers.

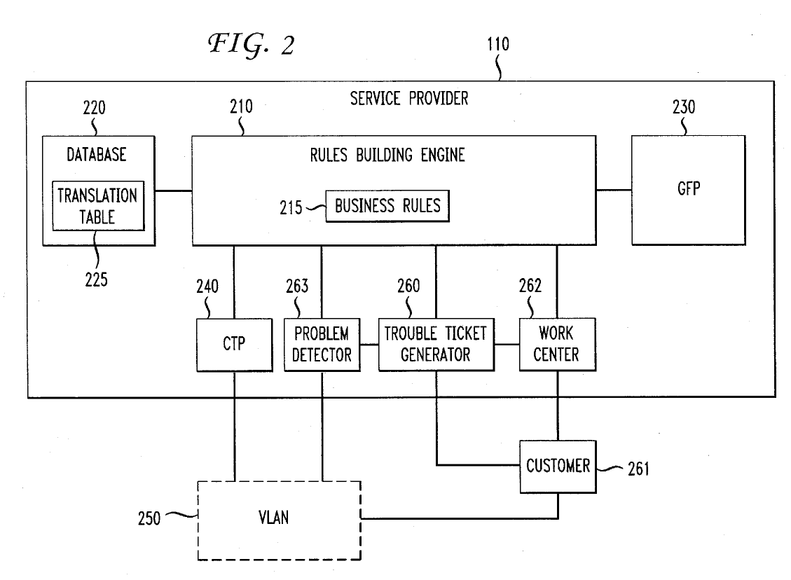

FIG. 2 shows an exemplary rules building engine 210 within the communication system 100 for automatic trouble diagnostics for MAC address limit problems within an exemplary VLAN 250 according to an exemplary embodiment of the present invention. It should be noted that the exemplary rules building engine 210 that will be discussed with reference to the generic benefits calculator 110 and components of the communication system 100 of FIG. 1.

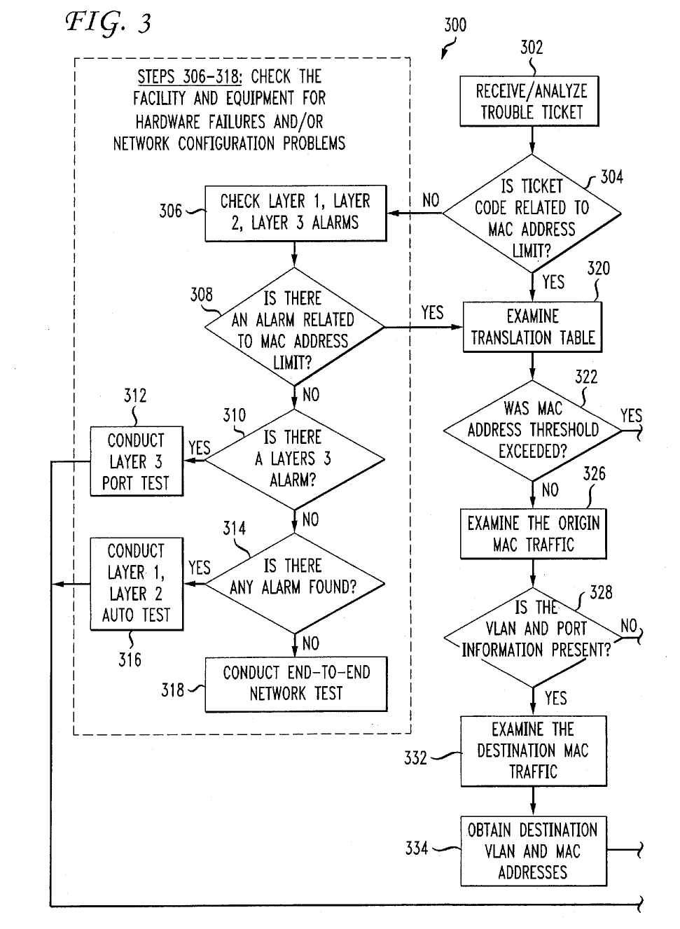

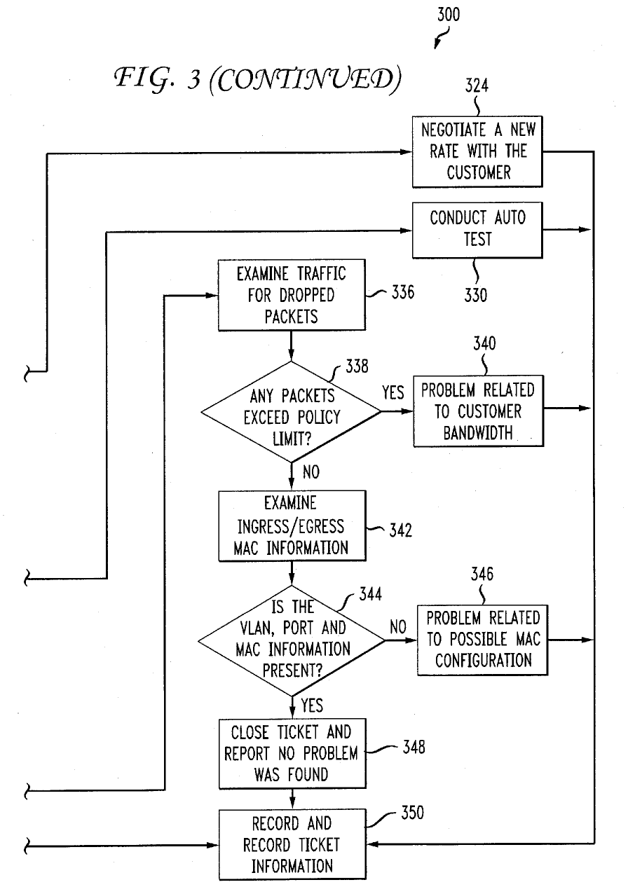

Accordingly, the rules building engine 210 may be a logic-driven analysis tool utilized by the service provider 110 within the communication system 110. The rules building engine 210 may include a dynamic set of business rules 215 for performing a MAC address diagnostic method on the exemplary VLAN 250. This diagnostic method will be described in greater detail in FIG. 3. It should be noted that even though only one VLAN 250 is depicted in FIG. 2, any number of customer VLANs may be analyzed by the rules building engine 210.

The rules building engine 210 may be in communication with a database 220, a global fault platform (“GFP”) 230, and a common test platform (“CTP”) 240. The exemplary database 220 (or record) may include a plurality of translation tables 225. Specifically, these translation tables 225 may record and track the MAC address data for each MAC address within any of the provided VLANs, such as the VLAN 250. Therefore, the rules building engine 210 may refer to the database 220 in order to obtain MAC address data on a particular VLAN.

The GFP 230 may be a network fault management system for monitoring network outages within any of the VLANs, such as the VLAN 250. Specifically, the GFP 230 may coordinate and filter any alarms or notifications (e.g., Layer 1, Layer 2, and Layer 3 alarms) generated within the VLAN 250, and provide notice to the rules building engine 210. For example, these alarms may be coordinated and filtered based on priority and/or actionable problems. Therefore, the rules building engine 210 may check with GFP 230 in order to determine if there are any high-priority, actionable circumstances (e.g., network outages) on the VLAN 250.

The CTP 240 may request for the rules building engine 210 to perform specific tests on any of the computers or network devices connected to one of the VLANs, such as the VLAN 250. These tests may include, but are not limited to, non-intrusive port tests on the various provider edge (“PE”) routers, automated intrusive tests on the various access Layers, end-to-end network connectivity tests, and network configuration verification. Accordingly, the CTP 240 may be in communication with both the rules building engine 210 and the Ethernet gateway switch 120.

The communication system 100 may further include a trouble ticket generator 260. Specifically, the trouble ticket generator 260 may be in communication with the rules building engine 210 and any one of a customer 261, work center personnel 262 (e.g., agent of the service provider 110), and an automated problem detector 263. Each of the customer 261, the work center personnel 262, and the automated problem detector 263 may initiate the generation a trouble ticket via contacting the trouble ticket generator 260. For example, the customer 261 may contact the trouble ticket generator 260 telephonically (e.g., via a interactive voice system) or through electronic communications (e.g., via an email) when a service problem is encountered. The work center personnel 262 may contact the trouble ticket generator 260 if a problem is encountered during routine manual inspections. The automated problem detector 263 may contact the trouble ticket generator 260 if a problem is detected. Once the trouble ticket has been generated, the trouble ticket generator 260 may transmit the ticket to the rules building engine 220 for trouble diagnostics.

FIG. 3 shows an exemplary method 300 for automatically performing trouble diagnostics on MAC address limit problems within a VLAN according to an exemplary embodiment of the present invention. It should be noted that method 300 that will be discussed with reference to both the communication system 100 of FIG. 1 as well as the rules building engine 210 of FIG. 2.

It is important to note that the exemplary method 300 may be one of several of logic methods used by the rules building engine 210. In other words, the logic and reasoning performed by the rules building engine 210 is not limited to the method 300. One skilled in the art would understand that a variety of alternative logic steps (e.g., decision steps) may be performed by the rules building engine 210 in accordance with the exemplary embodiments of the present invention in order to diagnose a problem stemming from VLANs exceeding their MAC address limits. Accordingly, the method 300 serves merely as one example of the analysis.

Beginning with step 302, the method 300 may receive and analyze a trouble ticket or a trouble report. According to the exemplary embodiments of the present invention, the rules building engine 210 may automatically capture (or trap) the trouble ticket/report from trouble ticket generator 260. For example, the ticket/report may be related to a potential problem within the VLAN 250. Accordingly, the rules building engine 210 may check the ticket/report for a trouble code. It should be noted that the trouble code may provide a description of an outstanding problem within the network and/or the services provided by the service provider 110, such as the VLAN 250.

In step 304, the method 300 may determine if the trouble code is related to a MAC address limit. Specifically, the rules building engine 210 may utilize the business rules 215 to identify the trouble code of the ticket/report. If the trouble code indicates a MAC address limit problem within the VLAN 250, then the method 300 may advance to step 320. However, if the trouble code is not related to the MAC address limit, then the method 300 may advance to step 306.

In step 306, the method 300 may check for Layer 1, Layer 2, and Layer 3 alarms. It should be noted that step 306 through step 318 may be directed towards automatically checking the facility and equipment to exclude any hardware failures or network configuration problems. Specifically, the rules building engine 210 may communicate with the GFP 230 in order to examine these potential alarms within the VLAN 250. One skilled in the art would understand that Layer 1 refers to the Physical Layer of the OSI model; Layer 2 refers to the Data Link Layer (including the LLC and MAC sub-layers); and Layer 3 refers to the Network Layer. Accordingly, the rules building engine 210 may examine alarm data provided by the GFP 230 within each of these system layers.

In step 308, the method 300 may determine if there is an alarm related to a VLAN MAC limit notification. Specifically, the rules building engine 210 may refer to the business rules 215 to determine if there is any indication of such an alarm in any of Layer 1, Layer 2, or Layer 3 of the VLAN 250. If there is an alarm related to a VLAN MAC limit notification, then the method 300 may advance to step 320. If there is not an alarm related to a VLAN MAC limit notification, then the method 300 may advance to step 310.

In step 310, the method 300 may determine if there was a Layer 3 alarm found. As described above, the Network Layer is Layer 3 in the OSI model of networking and, specifically, may respond to service requests from the Transport Layer and may issue service requests to the Data Link Layer. Accordingly, the Network Layer may be responsible for end-to-end (i.e., origin to destination) packet delivery, including any routing through intermediate hosts, whereas the link layer is responsible for node-to-node frame delivery on the same link. Therefore, the rules building engine 210 may communicate with the GFP 230 in order to determine if a Layer 3 network alarm has been reported within the VLAN 250. If there was not a Layer 3 alarm, then the method 300 may advance to step 314. If there was a Layer 3 alarm, then the method 300 may advance to step 312.

In step 312, the method 300 may conduct an existing Layer 3 non-intrusive port test. Specifically, the rules building engine 210 may instruct the CTP 240 to execute the Layer 3 non-intrusive port test. Upon conducting the port test in step 312, the method 300 may advance to step 350 for report and notification generation.

In step 314, the method 300 may determine if there was any alarm found (e.g., a Layer 1 alarm or a Layer 2 alarm). Similar to step 310, the rules building engine 210 may communicate with the GFP 230 in order to determine if a Layer 1 or Layer 2 alarm has been reported within the VLAN 250. If there is an alarm found, then the method 300 may advance to step 316. If there is no alarm found, then the method 300 may advance to step 318.

In step 316, the method 300 may conduct existing Layer 1 and Layer 2 automated intrusive tests (“auto tests”). Specifically, the rules building engine 210 may instruct the CTP 240 to execute these auto tests. Once the auto tests are performed, the method 300 may advance to step 350 for report and notification generation.

In step 318, the method 300 may conduct an existing end-to-end network connectivity test. Specifically, the rules building engine 210 may instruct the CTP 240 to execute the network test. Once the end-to-end network connectivity test is performed, the method 300 may advance to step 350 for report and notification generation.

As described above, the method 300 may advance to step 320 upon detection of trouble relating to a MAC address limit. This detection may be made in step 304 (e.g., via a trouble code) or, alternatively, in step 308 (e.g., via a related alarm). Accordingly, in step 320, the method 300 may examine one or more translation tables 225 within the database 220. Specifically, the rules building engine 210 may check the tables 225 in order to determine if the number of MAC addresses on the VLAN 250 has exceeded the threshold of total MAC address availability. For example, the rules building engine 210 may execute a count command, such as “show mac-address-table” count command, to get the requested MAC address information from the database 220.

In step 322, the method 300 may determine if the threshold, or maximum, number of MAC addresses within the VLAN 250 had exceeded the limit. If the maximum MAC address limit had been exceeded, then the method 300 may advance to step 324. If the limit was not exceeded, then the method 300 may advance to step 326.

In step 324, the method 300 may notify the work center personnel 262 to negotiate a new rate with the customer 261. In addition, a customer service agent of the work center personnel 262 may contact the customer 261 in order to adjust the rate of data transmission within the VLAN 250. Upon notifying the customer 261 in step 324, the method 300 may advance to step 350 for report and notification generation.

In step 326, the method 300 may examine the traffic over specific origin MAC addresses within the VLAN 250. Specifically, the rules building engine 210 may check with a host (e.g., an origin MAC address) location in order to determine if that host is sending frames of data. For example, the rules building engine 210 may execute a dynamic address command, such as “show mac-address-table” dynamic address command, with the origin MAC address to check the traffic form this origin MAC address.

In step 328, the method 300 may determine if there is VLAN and port information present within the traffic. Specifically, the rules building engine 210 may examine the frames of data sent from the origin MAC addresses for information related to the VLAN 250 and to the 10 GigE port 115. If there is no VLAN or port information present, then the method 300 may advance to step 3330. If there is VLAN or port information present, then the method 300 may advance to step 332.

In step 330, the method 300 may conduct an existing auto test to determine the cause of the MAC address limit problem. Specifically, the rules building engine 210 may instruct the CTP 240 to execute the auto test, wherein the possible root cause may be that a control-extensible router (“CER”) is not sending packets. Upon conducting the auto test in step 330, the method 300 may advance to step 350 for report and notification generation.

In step 332, the method 300 may examine the traffic at destination MAC addresses within the VLAN 250. Specifically, the rules building engine 210 may check destination MAC addresses in a content-addressable memory (“CAM”) in order to retrieve all VLAN and MAC address information. For example, the rules building engine 210 may execute a dynamic command, such as “show cam” dynamic address command with an interface string to retrieve the VLAN and MAC address information.

In step 334, the method 300 may obtain the destination VLAN and MAC address information. Specifically, upon executing the “show cam” command, the rules building engine 210 collect the VLAN and MAC address information for the VLAN 250.

In step 336, the method 300 may examine the traffic within the VLAN 250 for dropped packets. Specifically, the rules building engine 210 may check with an access control list (“ACL”) and a policy map in order to determine if packets are being dropped. According to one exemplary embodiment of the present invention, the policy map and the ACL may be included within the database 220 of the service provider 110. For example, the rules building engine 210 may execute an interface command, such as “show policy-map” interface command with interface string to tracking the packet delivery.

In step 338, the method 300 may determine if there are any packets that exceeded a policy limit. Specifically, the rules building engine 210 may reference the ACL and the policy map within the database 220. If any of the packets had exceeded the limits (e.g., policies) defined within the policy map, then the method 300 may advance to step 340. If the limits were not exceeded by any of the packets, then the method 300 may advance to step 342.

In step 340, the method 300 may notify the work center personnel 262 of a bandwidth problem. In addition, a customer service agent of the work center personnel 262 may contact the customer 261 in order to inform the customer 261 of the bandwidth problem within the VLAN 250. Upon notifying the customer 261 in step 340, the method 300 may advance to step 350 for report and notification generation.

In step 342, the method 300 may examine the MAC address information on both ingress and egress ports of the VLAN 250. The ingress port may handle the traffic traveling from the service provider 110 toward the customer's MAC address, while the egress port may handle the traffic traveling towards the service provider 110 from the customer's MAC address. Accordingly, the rules building engine 210 may execute a dynamic interface command, such as “show mac-address” dynamic interface command with the destination (or uplink) ports.

In step 344, the method 300 may determine if VLAN, port, and MAC address information are present. Specifically, the rules building engine 210 may examine the data sent from the destination ports for information related to the VLAN 250, the MAC address, and to the 10 GigE port 115. If there is not VLAN, port, and MAC address information, then method 300 may advance to step 346. If there is VLAN, port, and MAC address information, then the method 300 may advance to step 348.

In step 346, the method 300 may notify the work center personnel 262 of a potential MAC configuration problem. In addition, a customer service agent of the work center personnel 262 may contact the customer 261 in order to inform the customer 261 of the potential MAC configuration problem within the VLAN 250. Upon notifying the work center personnel 262 in step 346, the method 300 may advance to step 350 for report and notification generation.

In step 348, the method 300 may automatically close the trouble ticket and notify the work center personnel 262 that no problem was found. In addition, a customer service agent of the work center personnel 262 may contact the customer 261 in order to inform the customer 261 that there is no problem with the VLAN 250. Upon closing the trouble ticket and notifying the work center personnel 262 in step 348, the method 300 may advance to step 350 for report and notification generation.

In step 350, the method 300 may record and report the current diagnostics process and result. Specifically, the rules building engine 210 may generate a diagnostics report of the current trouble ticket. This report may include a detailed description of the trouble ticket, the trouble code, the alarms reported, the VLAN and MAC address data, the business rules utilized and the actions performed by the rules building engine 210, the conclusion as determined by the rules building engine 210, etc. Accordingly, this report may be used to follow with a customer 261 experiencing VLAN and MAC address problems. Furthermore, the report may be used to track any trends in problem occurrence, as well as to track the efficiency of the automated troubleshooting systems and methods.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
identifying a media access control (“MAC”) address alert within a network;
referencing a translation table of a plurality of MAC addresses to detect a whether a number of MAC addresses in the network exceeds a threshold number; and
providing a solution for the MAC address alert.

2. The method of claim 1, wherein the solution is to adjust a rate of transmission when the MAC addresses exceed the threshold number of the network.

3. The method of claim 1, wherein the solution is to adjust one of a MAC address configuration within the network and adjust a bandwidth within the network.

4. The method of claim 1, further comprising:
examining network traffic of source MAC addresses for at least one of port information and network information; and
conducting a test to determine if the source MAC addresses are transmitting data.

5. The method of claim 1, further comprising:
examining network traffic of destination MAC addresses for at least one of MAC information and network information; and
conducting a test using a policy map to determine if packets are dropped from transmitting data.

6. The method of claim 1, further comprising:
examining at least one of network equipment and facility for alarms; and
identifying the solution as related to one of a hardware failure and a network configuration problem from the solution to the MAC address alert.

7. The method of claim 6, wherein the examining includes performing at least one of a non-intrusive port test on one or more routers, an automated intrusive tests on one or more access layers, an end-to-end network connectivity test, and a network configuration verification.

8. The method of claim 1, wherein the network is a virtual local area network (“VLAN”).

9. A system, comprising:
a rules building engine for identifying a media access control (“MAC”) address alert within a network, referencing a translation table of a plurality of MAC addresses to detect a whether a number of MAC addresses in the network exceeds a threshold number, and providing a solution for the MAC address alert.

10. The system of claim 9, wherein the solution is to adjust a rate of transmission when the MAC addresses exceed the threshold number of the network.

11. The system of claim 9, wherein the solution is to adjust one of a MAC address configuration within the network and adjust a bandwidth within the network.

12. The system of claim 9, wherein the rules building engine examines network traffic of source MAC addresses for at least one of port information and network information, and conducts a test to determine if the source MAC addresses are transmitting data.

13. The system of claim 9, wherein the rules building engine examines network traffic of destination MAC addresses for at least one of MAC information and network information, and conducts a test using a policy map to determine if packets are dropped from transmitting data.

14. The system of claim 9, wherein the rules building engine examines at least one of network equipment and facility for alarms, and identifies the solution as related to one of a hardware failure and a network configuration problem from the solution to the MAC address alert.

15. The system of claim 14, wherein the examining includes performing at least one of a non-intrusive port test on one or more routers, an automated intrusive tests on one or more access layers, an end-to-end network connectivity test, and a network configuration verification.

16. A computer readable storage medium storing a set of instructions executable by a processor, the set of instructions being operable to:
identify a media access control (“MAC”) address alert within a network;
reference a translation table of a plurality of MAC addresses to detect a whether a number of MAC addresses in the network exceeds a threshold number; and
provide a solution for the MAC address alert.

17. The computer readable storage medium of claim 16, wherein the solution is to adjust a rate of transmission when the MAC addresses exceed the threshold number of the network.

18. The computer readable storage medium of claim 16, wherein the solution is to adjust one of a MAC address configuration within the network and adjust a bandwidth within the network.

19. The computer readable storage medium of claim 16, wherein the set of instructions are further operable to:
examine network traffic of source MAC addresses for at least one of port information and network information; and
conduct a test to determine if the source MAC addresses are transmitting data.

20. The computer readable storage medium of claim 16, wherein the set of instructions are further operable to:
examine network traffic of destination MAC addresses for at least one of MAC information and network information; and
conduct a test using a policy map to determine if packets are dropped from transmitting data.
